(19) United States
(12) Patent Application Publication
(10) Pub. No.: US 2018/0159404 A1
(43) Pub. Date: Jun. 7, 2018

(54) AIR-COOLED ELECTRIC MOTOR WITH A PARALLEL CIRCUIT OF TWO FAN WHEELS

(71) Applicant: CONTINENTAL AUTOMOTIVE GMBH, Hannover (DE)

(72) Inventors: Holger Fröhlich, Berlin (DE); David Charles, Berlin (DE); Robert Krause, Berlin (DE); Klaus Greger, Berlin (DE)

(73) Assignee: CONTINENTAL AUTOMOTIVE GMBH, Hannover (DE)

(21) Appl. No.: 15/889,955

(22) Filed: Feb. 6, 2018

Related U.S. Application Data
(63) Continuation of application No. PCT/EP2016/067860, filed on Jul. 27, 2016.

(30) Foreign Application Priority Data
Aug. 6, 2015 (DE) 10 2015 215 009.7

(51) Int. Cl. H02K 9/06; H02K 1/32; H02K 5/18; H02K 7/08; H02K 7/14; H02K 11/33

(52) U.S. Cl. CPC H02K 9/06; H02K 1/32; H02K 11/33; H02K 7/083; H02K 7/14; H02K 5/18

(57) ABSTRACT

An air-cooled electric motor having a parallel circuit of two fan wheels is discloses. The electric motor includes a belt tensioner attached on a fixed bearing side of the electric motor, an inverter housing arranged on a floating bearing side of the electric motor, and a fan system having a first fan wheel on the floating bearing side and a second fan wheel on the fixed bearing side. The first fan wheel suctions a cooling air volume flow from the environment radially inward and blows a first part of the suctioned air volume flow radially outward via a stator winding head on the floating bearing side, from the electric motor back into the environment. The second fan wheel suctions a second part of the air volume flow and blows it radially outward via a stator winding head on the fixed bearing side, from the electric motor back into the environment.

### CROSS-REFERENCE TO RELATED APPLICATIONS

This application claims the benefit of PCT Application PCT/EP2016/067860, filed Jul. 27, 2016, which claims priority to German Application DE 10 2015 215 009.7, filed Aug. 6, 2015. The disclosures of the above applications are incorporated herein by reference.

### TECHNICAL FIELD

The disclosure relates to an air-cooled electric motor, for example, a belt starter generator having a belt tensioner, an inverter housing, which is mounted on the electric motor or integrated into a motor housing or end plate of the electric motor, for a power, drive and control electronics system (inverter), and having a fan system which belongs to the motor.

### BACKGROUND

An apparatus for tensioning a V-ribbed belt, a so-called belt tensioner, which can be mounted in a space-saving manner directly on the housing of the output side and/or on the fixed bearing side, is required for electrically operated vehicles and for partially electrically operated vehicles with a hybrid motor or when a belt starter generator is used. The technological background in this respect is known, for example, from DE 10 2011 080 886 A1, DE 10 2013 109 294 A1 and EP 1929611 B1. However, the belt tensioner can constitute a barrier to drawing in cooling air since it can close a possible coolant supply via the housing or slots in an end plate.

### SUMMARY

The disclosure provides an air-cooled electric motor that provides effective cooling of the assembly as a whole and is performed in a space-saving manner.

The air-cooled electric motor according to the disclosure includes a belt tensioner which is fitted on a fixed bearing side of the electric motor, an inverter housing which is arranged on a floating bearing side of the electric motor, and a fan system having a floating bearing-side first fan wheel or impeller and a fixed bearing-side second fan wheel.

The first fan wheel is designed to draw a cooling air volume flow radially inward from the area surrounding the electric motor via cooling ribs of a floating bearing-side end plate which is arranged axially adjacent to the inverter housing and to blow a first proportion of the drawn-in air volume flow radially outward out of the electric motor via a floating bearing-side stator end winding. The second fan wheel is designed to draw a second proportion of the radially inwardly drawn air volume flow axially into and through a rotor, for example, by means of air channels of a rotor laminated core of the rotor, and to blow it radially outward out of the electric motor via a fixed bearing-side stator end winding.

The “fixed bearing side” of the electric motor or “fixed bearing-side” relates, in this context, to that side on which a first axial end section of the electric motor is arranged, where the first end section, for example a first axial end section of a motor housing or a first end plate, accommodates an axial fixed bearing.

On the contrary, the “floating bearing side” of the electric motor or “floating bearing-side” relates to that side on which a second axial end section of the electric motor is arranged, where the second end section, for example a second axial end section of a motor housing or a second end plate, accommodates an axial floating bearing.

The air-cooled electric motor according to the disclosure therefore has a parallel circuit including two fan wheels, where the first fan wheel allows cooling air to be exclusively radially drawn in. As a result, the fact that the belt tensioner may possibly constitute a barrier to axially drawing in air via the fixed bearing side does not present an obstacle. Due to the possibility of radially drawing in air on the floating bearing side or inverter side, slots, apertures or the like for axially drawing in air in the housing or end plate can be omitted on the fixed bearing side. As a result, the mechanical stability of the housing or end plate can be increased. In other words, it is not necessary to weaken the cross section of the housing or end plate around the housing bearing seat on the fixed bearing side, this also being accompanied by higher bearing rigidity for the fixed bearing.

Since the floating bearing-side end plate is arranged axially adjacent to the inverter housing, for example, an inverter which is accommodated in the inverter housing, the floating bearing-side end winding, the rotor and the fixed bearing-side end winding can be cooled by an open, parallel cooling circuit.

In this case, an “open” cooling circuit is intended to be understood to mean that an air inlet of the cooling circuit for drawing in the cooling air volume flow from the surrounding area and an air outlet of the cooling circuit for blowing the heated air volume flow out to the surrounding area are not connected to one another. In this case, a “parallel” cooling circuit is intended to be understood to mean that the drawn-in cooling air volume flow is divided into two volume flow elements which are formed by the first and the second proportion of the air volume flow.

In other words, the open, parallel cooling circuit allows the stator end winding to be cooled on the floating bearing side in a first of the parallel circuits after cooling of the inverter or of the inverter housing during suction operation. The rotor and then the stator end winding of the fixed bearing side are cooled in a second of the parallel circuits after cooling of the inverter or of the inverter housing during suction operation.

The first fan wheel and the second fan wheel may be integrally formed on short-circuiting rings of the rotor. In this context, “integrally formed” is intended to be understood to mean that the fan wheels are each integrated into a short-circuiting ring of the rotor, that is to say the respective short-circuiting ring and the respective fan wheel are connected to one another in one piece. This allows a reduction in weight and lower expenditure on manufacture.

In some implementations, the first fan wheel and the second fan wheel are structurally identical. During parallel operation of the two structurally identical fan wheels, the needed air volume flow can be doubled. This means that double the air throughput along the cooling ribs of the end plate and along the inner side of the inverter housing may be achieved with the same air throughput for cooling for each end winding.

Furthermore, in some examples, an air guide sleeve is arranged on a rotor shaft between the cooling ribs of the floating bearing-side end plate and the first fan wheel. The guide sleeve may be designed without blades or with blades. The air guide sleeve allows particularly targeted, effective and efficient guidance of the air from the cooling ribs in the direction of the channels of the rotor and in the direction of blades of the wheels.

In some implementations, it is furthermore provided that an air guide plate which has an L-shaped cross section is arranged between the first fan wheel and the first end plate, the air guide plate guiding the first proportion of the drawn-in air volume flow particularly efficiently over the floating bearing-side stator end winding. In addition, the air guide plate serves as a stationary housing half or as a covering disk of the fan wheel and prevents a short-circuiting current through the heat sink in the interior of the electric motor.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective illustration of a longitudinal section through a known air-cooled electric motor.

FIG. 2 is an illustration of a longitudinal section through an exemplary embodiment of an air-cooled electric motor

FIG. 3 is an exploded illustration of the electric motor according to FIG. 2.

FIG. 4 shows a circuit diagram of the fan wheels of the electric motor according to FIG. 1.

Like reference symbols in the various drawings indicate like elements.

### DETAILED DESCRIPTION

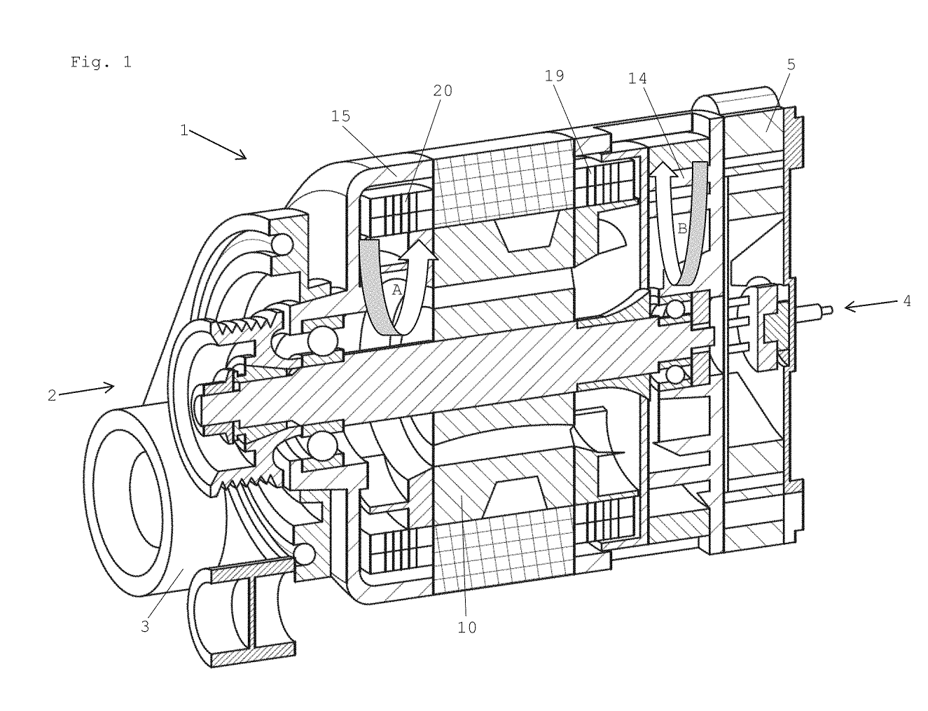

FIG. 1 shows an air-cooled electric motor 1 which includes a belt tensioner 3 which is fitted on a fixed bearing side 2 of an electric motor 1, and an inverter housing 5 which is arranged on a floating bearing side 4 of the electric motor 1. The electric motor 1 furthermore includes a floating bearing-side first motor plate 14 and a fixed bearing-side second motor plate 15. In particular, a rotor 10 of the electric motor 1, the inverter housing 5 and stator end windings 19, 20 of a stator 18 of the electric motor 1 are cooled by two cooling circuits A and B.

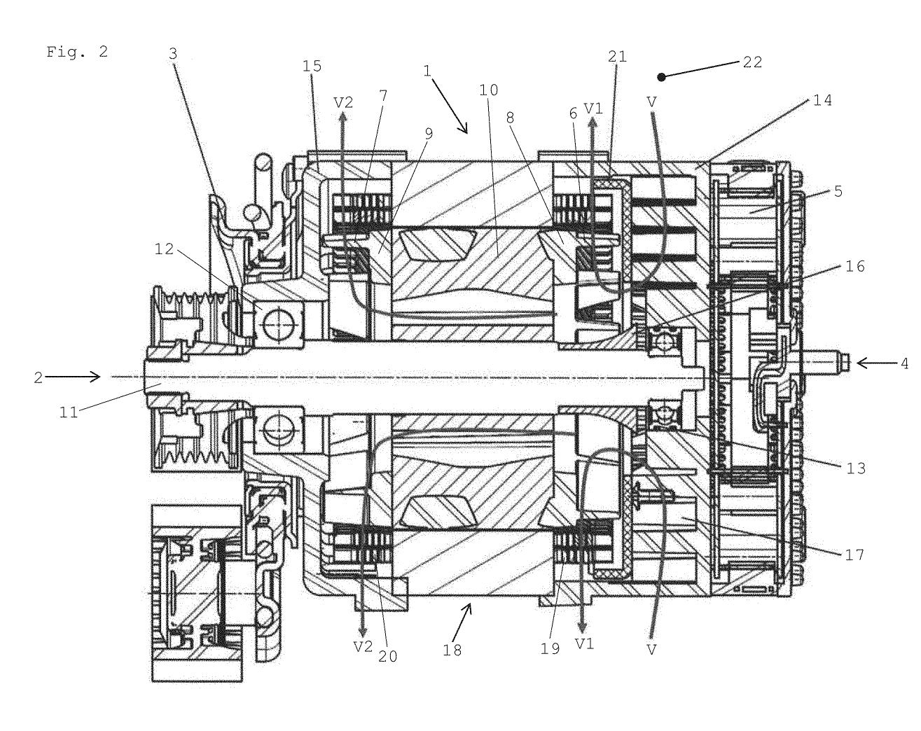

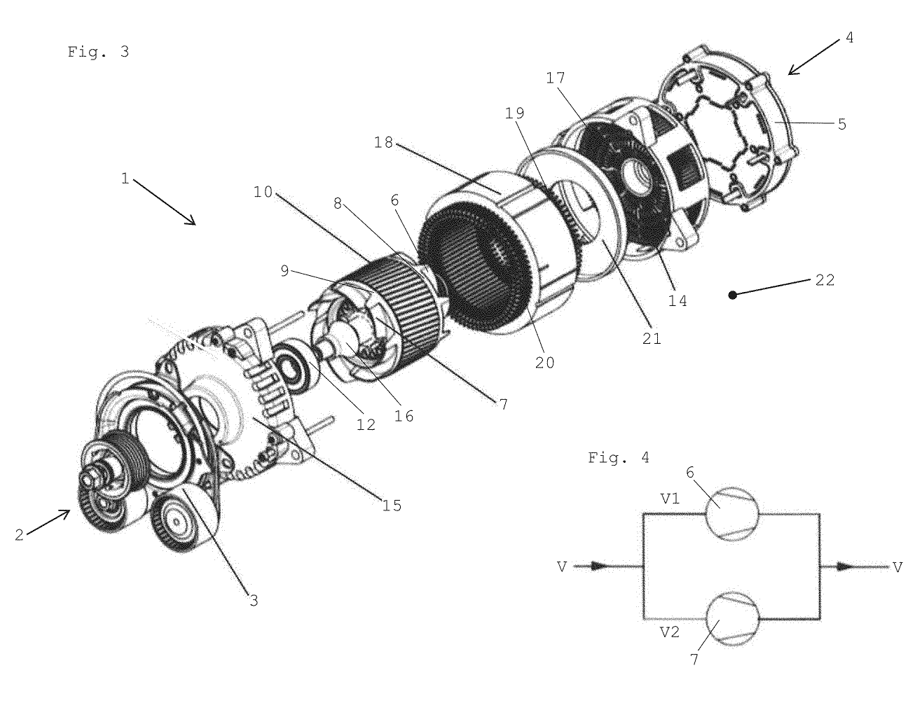

FIGS. 2 and 3 show an air-cooled electric motor 1 which includes a belt tensioner 3 which is fitted on a fixed bearing side 2 of the electric motor 1, an inverter housing 5 which is arranged on a floating bearing side 4 of the electric motor 1, and a fan system having a floating bearing-side first fan wheel 6 and a fixed bearing-side second fan wheel 7.

The first fan wheel 6 and the second fan wheel 7 are structurally identical and are each integrally formed on a floating bearing-side short-circuiting ring 8 or a fixed bearing-side short-circuiting ring 9 of a rotor 10. The rotor 10 is mounted in a rotationally fixed manner on a rotor shaft 11 which is shown by FIG. 1. The rotor shaft 11 is rotatably mounted in a fixed bearing 12 and a floating bearing 13. The floating bearing 13 is mounted in an axially movable manner in a first end plate 14 on the side of the inverter housing 5 which is arranged axially adjacent to the inverter housing 5, or, in integral design (heat sink, bearing and inverter carrier), constitutes part of the inverter housing. The fixed bearing 12 is mounted in an axially fixed manner in a second end plate 15 on the side of the belt tensioner 3. Furthermore, an air guide sleeve 16 is arranged between cooling ribs 17 of the floating bearing-side first end plate 14 and the first fan wheel 6 on the rotor shaft 11.

A stator 18 is arranged in an immobile manner between the first end plate 14 and the second end plate 15 and surrounds the rotor 10. The stator 18 includes a floating bearing-side stator end winding 19 and a fixed bearing-side stator end winding 20, where the stator end windings 19 and 20 are arranged on opposite end regions of the stator 18 and are each radially surrounded by one of the end plates 14 and, respectively, 15. Furthermore, an air guide plate 21 which has an L-shaped cross section is arranged between the first fan wheel 6 and the first end plate 14.

By means of the first fan wheel 6, a cooling air volume flow V can be drawn radially inward from the area 22 surrounding the electric motor 1 via the cooling ribs 17 of the floating bearing-side end plate 14 and the air guide sleeve 16. A first proportion V1 of the drawn-in air volume flow V can be blown radially outward out of the electric motor 1 via the floating bearing-side stator end winding 19, where the first proportion V1 of the air volume flow V is guided in a corresponding manner via the air guide plate 21. By means of the second fan wheel 7, a second proportion V2 of the radially inwardly drawn air volume flow V can be drawn axially into and through the rotor 10 and blown radially outward out of the electric motor 1 via the fixed bearing-side stator end winding 20.

FIG. 4 illustrates the division of the air volume flow V which is drawn in from the area 22 surrounding the electric motor 1 into a first proportion V1 and a second proportion V2 by the first fan wheel 6 or the second fan wheel 7, wherein the two proportions V1 and V2 are output to the surrounding area 22 again.

A number of implementations have been described. Nevertheless, it will be understood that various modifications may be made without departing from the spirit and scope of the disclosure. Accordingly, other implementations are within the scope of the following claims.

What is claimed is:

1. An air-cooled electric motor comprising:
a fixed bearing side of the electric motor;
a belt tensioner which is fitted on the fixed bearing side of the electric motor;
a floating bearing side of the electric motor;
an inverter housing which is arranged on the floating bearing side of the electric motor;
cooling ribs of a floating bearing-side end plate which is arranged axially adjacent to the inverter housing;
a floating bearing-side stator end winding;
a fixed bearing-side stator end winding
a rotor; and
a fan system including:
a floating bearing-side first fan wheel, designed to draw a cooling air volume flow radially inward from an area surrounding the electric motor via the cooling ribs and to blow a first proportion of a drawn-in air volume flow radially outward out of the electric motor via the floating bearing-side stator end winding, and
a fixed bearing-side second fan wheel is designed to draw a second proportion of the radially inwardly drawn-in air volume flow axially into and through the rotor and to blow it radially outward out of the electric motor via the fixed bearing-side stator end winding.

2. The air-cooled electric motor of claim 1, wherein the first fan wheel and the second fan wheel are integrally formed on short-circuiting rings.

3. The air-cooled electric motor of claim 1, wherein the first fan wheel and the second fan wheel are structurally identical.

4. The air-cooled electric motor of claim 1, further comprising an air guide sleeve arranged on a rotor shaft between the cooling ribs of the floating bearing-side end plate and the first fan wheel.

5. The air-cooled electric motor of claim 1, further comprising an air guide plate having an L-shaped cross section arranged between the first fan wheel and the floating bearing-side end plate.
